(19) United States
(12) Patent Application Publication
(10) Pub. No.: US 2007/0094259 A1
(43) Pub. Date: Apr. 26, 2007

(54) Methods and apparatus for information recommendation

(75) Inventor: Xiaowei Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,379

(22) PCT Filed: Dec. 10, 2004
(86) PCT No.: PCT/IB04/52749

§ 371 Date: Jun. 12, 2006

(30) Foreign Application Priority Data
Dec. 15, 2003 (CN) 200310123354.7

(51) Int. Cl. G06F 17/30

(52) U.S. Cl. 707/9

(57) ABSTRACT

The invention presents an method and system for information recommendation based on the fuzzy logic. The method includes: storing the user files with the fuzzy set, matching the user file with the received information by inference of the fuzzy logic, sieving out the information which conforms to the user's preference and recommending the information to the user after sequencing the information according to the preference thereof. The system includes means for carrying out above method. Said method and system for information recommendation can imitate the human thinking intelligently, hence increase greatly the efficiency and the satisfaction level of the information recommendation, so can be applied to the information recommendation of TV programs, shopping or the Internet and so on.

### FIELD OF THE INVENTION

The invention relates to an information recommendation system and method, in particular relates to a technology, which can recommend information to users intellectually.

### BACKGROUND OF THE INVENTION

With the development of the modem communication technology, at any time they want, people have the access to a great deal of information. However, the sudden flood of information, sometimes, makes people feel at a lost. People are seeking desperately for a tool helping them find the things they want right away, namely, a personal information recommendation system.

FIG. 1 shows the structure diagram of the information recommendation system in prior art. This system includes an information receiving means 160, for receiving information; a user file storing means 110, for storing the user's interest characteristic in an explicit manner, which, however, only contains the characteristics of the things that the user likes, instead of that of the things which the user detests(dislikes); a matching means 120, for explicitly comparing the user's interest characteristic and the information received to calculate to obtain the interest-degree, which is a value, for the user; a sieving means 130, for sorting out the information the user may be interested in and recommend it to the user according to the interest-degree obtained through the calculation,; an user communicating means 140, for communicating information between the user and the recommendation system, through which the user may select those information he feels like to read, delete those needless ones, or revise his own user file; and an user file revising means 150, for updating the user's file according to the feedback given by the user continuously.

However, the user file, matching, sieving and recommending methods of the present information recommendation system are based on explicit manner only. While, the explicit manner adopts a “yes or no”, one-cut approach to evaluate information, which is rather mechanical. It cannot simulate the human thinking to analyze and deduct in a flexible and intelligent manner. Therefore, for those information comprising both the client's like and detested characteristic, the use of the explicit manner often comes to a self-contradictory conclusion.

In addition, in the present information recommendation system, the user file storing means may usually only store some characteristic that the user likes, while lacks those that the user dislikes. Therefore, the system can only recommend information based on the characteristic that the user likes, which lowers the accuracy of the recommended contents.

Moreover, the present recommendation system, usually based on the value obtained through the calculation, provides the user with a recommending list, which, however, does not indicate the user's interest-degree with regards to each recommendation. That is to say the list cannot provide the user with a tailored and intuitionistic recommendation result, for example, showing the information the user might be “interested ” in or “much interested ” in. Besides that, the present information recommendation system usually applies to a single area only. For instance, the recommendation system used for TV programs does not apply to Internet, for one same user, which often can be very inconvenient.

### SUMMERY OF THE INVENTION

This invention provides an information recommendation method. First, it receives information, each of which comprises specific information characteristics. Second, the said information may be matched with a user file by inference of the fuzzy logic. The user file is established as a fuzzy set, including the user's selecting characteristics, which comprises the characteristic that the user likes and dislikes. Each selecting characteristic contains one ternary array, including content characteristics, preference and weight. Specifically speaking, matching the information with the user file is to match the specific information characteristic of each information with the corresponding selecting characteristic in the user file. By way of inference of fuzzy logic, the interest-degree for each specific information characteristic is thus obtained. Based on the obtained interest-degree for each information characteristic, the user's comprehensive interest-degree is then obtained through a further match. Finally, according to the result of the matching, those information, which meet all the predetermined requirements, can be recommended to the user.

Furthermore, the method further comprise determining the actual interest-degree of the user to update or revise the user file dynamically, according to the relative ratio of the time in which the user watches the recommended information to the time in which said information is predetermined to broadcast.

This invention provides an information recommendation system, including a information receiving means for receiving information; a fuzzy matching means for matching the information received with a user file by inference of fuzzy logic; a sieving means for recommending the information which conforms to the predetermined conditions to the user according to the matching result.

Furthermore, this system further comprises: a user communicating means for user's communicating the information with the recommendation system; a user file revising means for updating user's file according to the user's feedback to the recommended information; a fuzzy user file managing means for storing the fuzzy user files.

This invention adopts a fuzzy set in the user file to define all the selecting characteristics of the user, and then match the user file with the obtainable information by inference of fuzzy logic, then makes the recommendations to users. The system can also dynamically revise the user file according to the feedback from the user. Therefore, the system can intellectually determine if certain vague information, which involves both the characteristics that the user likes and dislikes, should be recommended to the users. In this way, the efficient and satisfactory of information recommendation are improved. At the same time, the recommendation system and the method of the invention are applicable to other systems and devices as well. For example, it is not only used to recommend radio or TV programs, but also can be used to recommend information in case of shopping or surfing on Internet.

It is obvious to see other purposes and achievements of this invention, with the reference to the figures below and the descriptions and claims as stated below.

### DESCRIPTION OF DRAWINGS

The detail explanation to this invention is made by way of embodiments, with reference to the figures below, in which:

FIG. 1 is a structure diagram of the present information recommendation system;

FIG. 2 is a structure diagram of the information recommendation system according to an embodiment of the invention;

FIG. 3 is a flow chart of information recommendation according to an embodiment of the invention;

FIG. 4 is a flow chart of the similarity matching according to an embodiment of the invention;

FIG. 5 is a fuzzy set of the weight and preference in the user file according to an embodiment of the invention;

FIG. 6 is a fuzzy set of the interest-degree for the specific information characteristic according to an embodiment of the invention;

FIG. 7 is a sketch map showing the result of mapping the interest-degree for the information characteristic of a program to a fuzzy set of the user file according to an embodiment of the invention;

FIG. 8 is a sketch map showing the result of mapping the interest degree for the information characteristic to its fuzzy set according to an embodiment of the invention;

FIG. 9 is a sketch map showing the result of mapping the comprehensive interest-degree for a program to its fussy set according to an embodiment of the invention.

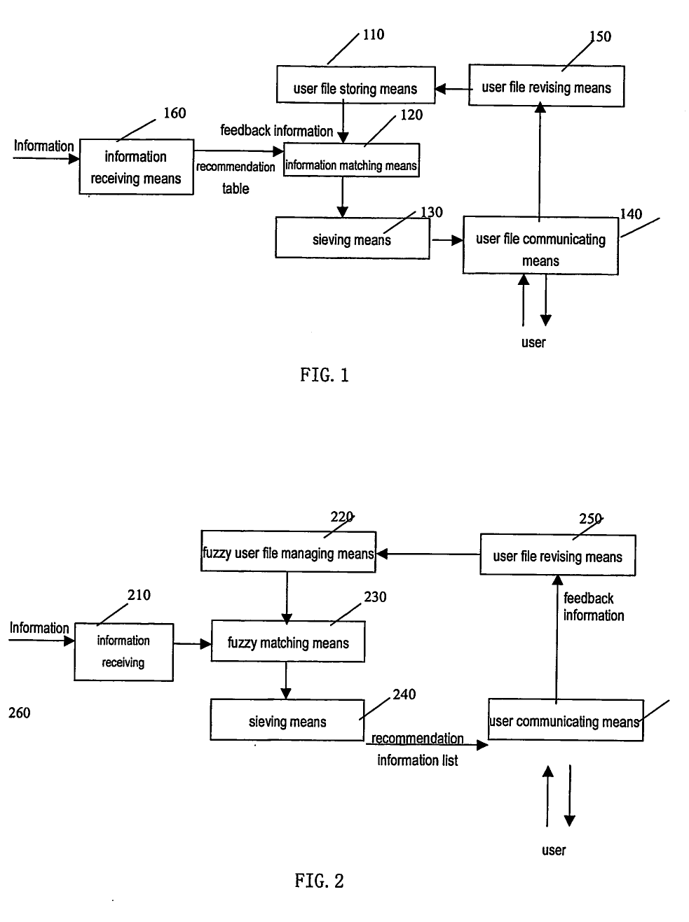

Among all the figures, the same reference number stands for similar or identical characteristic and function. A further explanation to this invention is made according to an embodiment and the figures following.

### DESCRIPTION OF THE PREFERRED EMBODIMENTS

FIG. 2 shows the structure of the information recommendation system according to an embodiment of the invention. The information recommendation system contains an information receiving means 210, a fuzzy matching means 230 and a sieving means 240.

The information receiving means 210 is used for collecting information from the outside. The said information, containing specific information characteristic, might come from broadcasting, TV station, Internet or any other sources, for example, a digital TV Electronic Program Guide. (EPG)

The fuzzy matching means 230 is used for conducting a similarity match between the information received and the user file by inference of fuzzy logic. The similarity matching involves: establishing the transforming relationship between input and output variables; fuzzing the selecting characteristic and the interest-degree for the specific information characteristic; obtaining the interest-degree for the specific information characteristic by fuzzy inference; de-fuzzing the interest-degree for the specific information characteristic; and according to the interest-degrees for each specific information characteristic, finally obtaining the comprehensive interest-degree for that information.

The sieving means 240 is used for sieving the information, which the user is interested in, through the predetermined thresholds. The sieved information will be ordered in according to the values of their interest-degrees respectively, and generate a recommendation table for the user.

The information recommendation system also contains a fuzzy user file managing means 220, which is use for fuzzy sets to store the user file. The user file contains many user's selecting characteristic.

This information recommendation system also contains a user communicating means 260, for exchanging information between the user and the system, through which the user can select the information he wants to watch, and delete those he doesn't want or revise his own user file; and This recommendation system also contains a user file revising means 250, for dynamically updating or revising user file according the feedback information from the user. That is to say, the system, according to the relative ratio of the time in which the user watches the recommended information to the time in which the said information is predetermined to broadcast, determines the actual interest-degree of the user, so as to update the user's parameters.

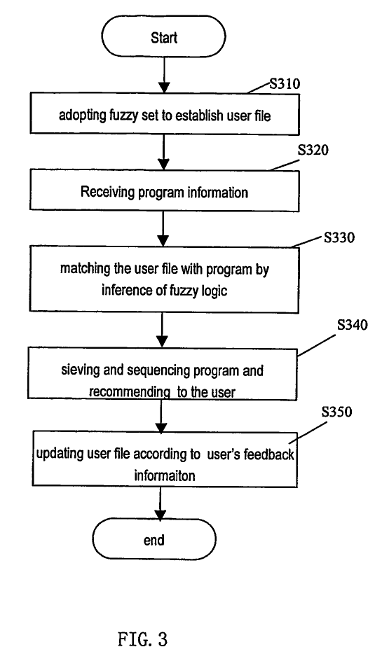

FIG. 3 is a flow chart of information recommendation according to an embodiment of the invention.

Firstly, a user file is established by fuzzy sets (step S310). This user file can be filled by the user himself and then be initialized. Of course, it is not the only way to establish a user file. Many other ways are available. For example, the manufacturer can initialize the user file for the said recommendation system. In the user file, there are a series of selecting characteristic available to indicate the information which the user likes or dislikes. Every selecting characteristic may contain a ternary array (term, preference, weight). The user file can be displayed as a vector of one ternary array (t, ld, w). If there are m different selecting characteristic, the user file can be shown by the following vector set:
UP=((t₁, ld₁, w₁), (t₂, ld₂, w₂), . . . (tᵢ, ldᵢ,wᵢ) . . . , (tₘ, ldₘ, wₘ)) (1)

Here, tᵢ is a content characteristic, i is the serial number of content characteristic tᵢ; while ldᵢ is the preference for the selecting characteristic ti, and wᵢ is the weight for the selecting characteristic ti. Weight means the relative important degree of the selecting characteristic in the user file. For example, some users may care more about the program genre, in his file, the weight of program genre is then greater; some may care more about actors, the weight of actor is then greater in his file. Preference shows the user's feeling towards certain content characteristic.

For instance, we have a user A. His user file after initialization is as follows:

Program genre: weight=0.9

Movie preference=0.5

Opera preference=0.3

News preference=−0.2, here the negative means the degree of dislike

The selecting characteristic of a program genre is (movie, 0.5, 0.9);

Actor: weight=0.8

Xu Jinglei preference=0.1

Ge You preference=0.5

Li qinqin preference=−0.125

The selecting characteristic of an actor may be (Li qinqin, −0.125, 0.8)

Then, certain program information is to be received (step S320). For example, a metadata including a TV program of an Electronic Program Guide for digital TV. The metadata of the TV program includes many specific information characteristic, for example: genre, language, actor, keyword. One program may be expressed by a vector formula containing n specific information characteristic:
C=(u₁, . . . , uₙ) (2)
in which, un is the characteristic of the n-th specific information characteristic.

For instance, such a TV program has been received: the movie, “Cala, My Dog”, which contains the following specific information characteristic: actor: “Ge You ” and “Li Qinqin”, the genre is “movie ” and the predetermined length of the program is 2 hours.

Then, by the inference of fuzzy logic, a similarity match shall be conducted between the user file and the program received, so as to obtain the comprehensive interest-degree for the program (step S330). In a typical vector space expression, the similarity between the two vectors of the program and the user file can be used to express the correlation between the program and the user file. In this embodiment, the system by inference of fuzzy logic, conducts a similarity match between the user file A and the program.

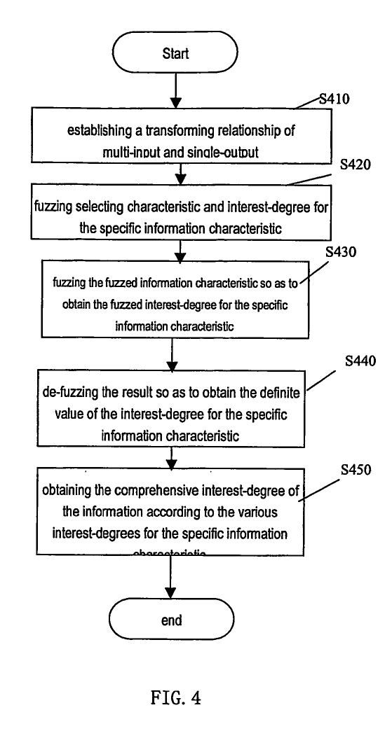

The similarity matching process comprises: matching the specific information characteristic of the program with the selecting characteristic in the user file to obtain the interest-degree for the specific information characteristic by inference of fuzzy logic. Secondly, further matching the interest-degree obtained to get the comprehensive interest-degree of the program. In this embodiment, the comprehensive interest-degree for the program “Cala, My Dog” of the user, obtained through the final matching processes, is 0.45. How to conduct the similarity match by inference of fuzzy logic will be explained in details with FIG. 4.

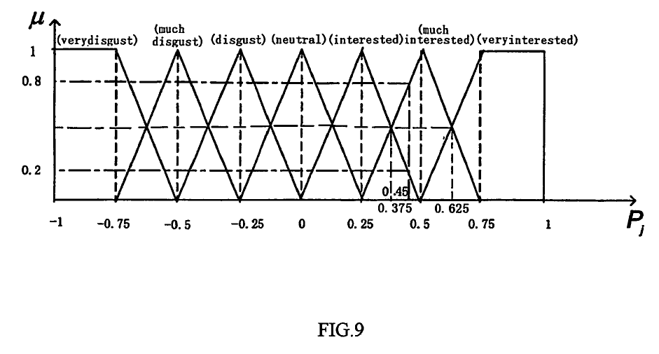

In the fuzzy set of this embodiment, the interest-degree of the user can be in turn categorized into “very disgust”, “much disgust”, “disgust”, “neutral”, “interested”, “much interested”, and “very interested”. Of course, the said categorization is not unvaried, which can be adjusted according to the circumstances. Therefore, mapping the comprehensive interest-degree 0.45 into the fuzzy set of the comprehensive interest-degree, and obtains that the user's attitude to the movie is between “interested ” and “much interested”. (Detailed explanation will be made together with FIG. 9)

Finally, the matched program will be sieved and ordered and then recommended to the user (step S340). A threshold can be set, through which the program that the user is really interested in can be sieved. The threshold can be the value of the comprehensive interest-degree only or can be one that satisfies the threshold of an affiliation degree p of a certain set. The affiliation degree p ranges between 0 to 1, indicating the degree of certain characteristic or interest. If the interest-degree is greater than the threshold, it means the user is interested in it, and then the program will be selected. The interest-degree for various programs will be ordered according to the values thereof, and then recommended to the user in an ordered sequence. Obviously, the greater the interest-degree for certain program is, the more the user is interested in it.

In this embodiment, the threshold is set as: the interest-degree is “much interested”, and μ_{much interested}=0.5, which then mapped to the fuzzy set of the comprehensive interest-degree, two values are met, namely 0.375 and 0.625 (explanation will be made together with FIG. 9). The minimum value is selected as λ=0.375. Any information, whose comprehensive interest-degree is greater than λ, meet the requirement. Obviously, the comprehensive interest-degree for the movie “Cala, My Dog ” is 0.45, which is greater than λ, and therefore is recommended to the user.

Next, all the sieved information will be ordered, according to the interest-degree of the program. The programs will be then recommended to the user in an ordered sequence. It is obvious to see that, the greater the interest-degree is for certain program, the more the user is interested in it. If the interest-degree is below 0, it is easy to tell that the user is not interested in it at all. Assumed that there might be some other programs to be recommended to the user, for example, “the Empty Mirror”, whose comprehensive interest-degree is 0.8; while “Tell It As It Is”, whose comprehensive interest-degree is 0.5 etc. The priority sequence in the recommendation list shall be: “The Empty Mirror”, “Tell It As It Is” and “Cala, My dog”. Combined with Electronic Program Guide (EPG), the recommendation system can provide users with TV program information, enabling them to know when, and on which channel, they can find their interested program, and what the interest-degree is, which is shown as the following table:

| Channel | Broadcasting Time | Name | Interest Degree |
|---|---|---|---|
| Hunan | Sep. 18 15:30 | The Empty Mirror | 0.8 (very |
| Satellite | | | interested) |
| TV | | | |
| CCTV 1 | Sep. 18 19:30 | Tell it as it is | 0.5 (much |
| | | | interested) |
| CCTV 6 | Sep. 18 21:30 | Cala, My Dog | 0.45 (much |
| | | | interested) |

Furthermore, this embodiment can also determine the user's actual interest-degree according to the relative ratio of the time in which the user watches the recommended information to the time in which said information is predetermined to broadcast actually, so as to update the user file (step S350).

For those program recommended, the user always has three attitudes towards them: skip, delete or watch. In other words, the user will skip or delete the program not so interesting to them while watch the program they are interested in or likely to be interested in. For the program i, the user file can be updated according to the user's feedback,

$$\begin{matrix}{Weight}_{i}^{′} = {Weight}_{i} + α \cdot \frac{( {WD}_{i} - θ )}{{RD}_{i}} & ( 5 ) \\ Like - {degree}_{i}^{′} = Like - {degree}_{i} + β \frac{( {WD}_{i} - θ )}{{RD}_{i}} & ( 6 )\end{matrix}$$

Here, WDᵢ is the total time that the user actually watches the program; RDᵢ is the time that the program is predetermined to broadcast; E is the threshold for the watching time. Where WDᵢ is less than θ, it means that the user is not interested in the information recommended, therefore the relevant weight and preference shall be decreased accordingly. α and β are constants, which are used to postpone the change of weight and preference, and both are less than 1. Since the weight for the user's fondness is relatively stable, therefore α≦β.

If weight′ᵢ is more than its higher-boundary, then Weight′ᵢ=higer-boundary;

If weight′ᵢ is less than its lower-boundary, then Weight′ᵢ=lower-boundary;

If Preference′ᵢ is more than its higher-boundary, then Preference′ᵢ=higer-boundary;

If Preference′ᵢ is less than its lower-boundary, then Preference′ᵢ=lower-boundary;

For user file A, assumed:

If Weight′ᵢ is more than 1, then Weight′ᵢ=1

If Weight′ᵢ is less than o, then Weight′ᵢ=0;

If Preference′ᵢ is more than 0.5, then Preference′₁=0.5;

If Preference′ᵢ is less than −0.5, then Preference′ᵢ=−0.5.

If the threshold for the time that the user watches the movie “Cala, My Dog”,

θ=20 minutes; user A actually watches it altogether for WDᵢ=2 hours, and the movie is predetermined to be broadcast for RDᵢ=2 hours; α=0.01, and

β=0.1. According to the aforementioned formula, the updated user file A is:

Program genre: weight=0.9083

Movie preference=0.583

Opera preference=0.3

News preference=−0.2

The selecting characteristics for the said movie is changed into (movie, 0.583, 0.9083);

Actors: weight=0.8083

Xu Jinglei preference=0.1

Ge You preference=0.583=0.5 (because 0.5 is the higher boundary)

Li Qinqin preference=−0.125+0.083=−0.042

The selecting characteristic for the said actress will be (Li Qinqin, −e0.042, 0.8083);

FIG. 4 is a flow chart of the similarity matching according to an embodiment of the invention. The correlation degree of certain specific information characteristic of a program with a user file is determined, ie. the specific information characteristic of the program is mapped to the user file, so as to obtain the preference and weight thereof, and then to obtain the interest-degree for the specific information characteristic, according to fuzzy logic control theory.

Firstly, a transforming relationship between multi-input variables and a single output variable may be established (Step S410). The preference and weight in the user file may be selected as the input variables, while the interest-degree for specific information characteristic may be selected as the output variable.

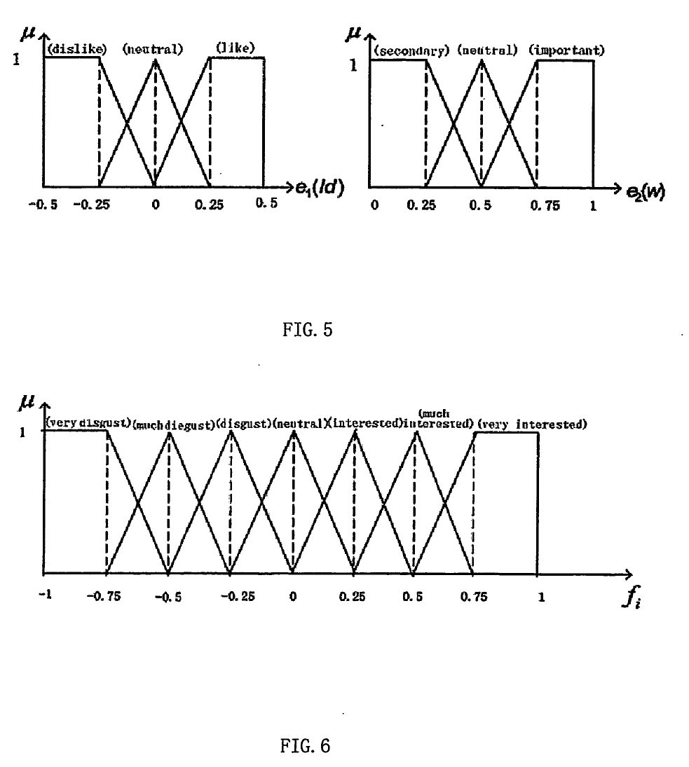

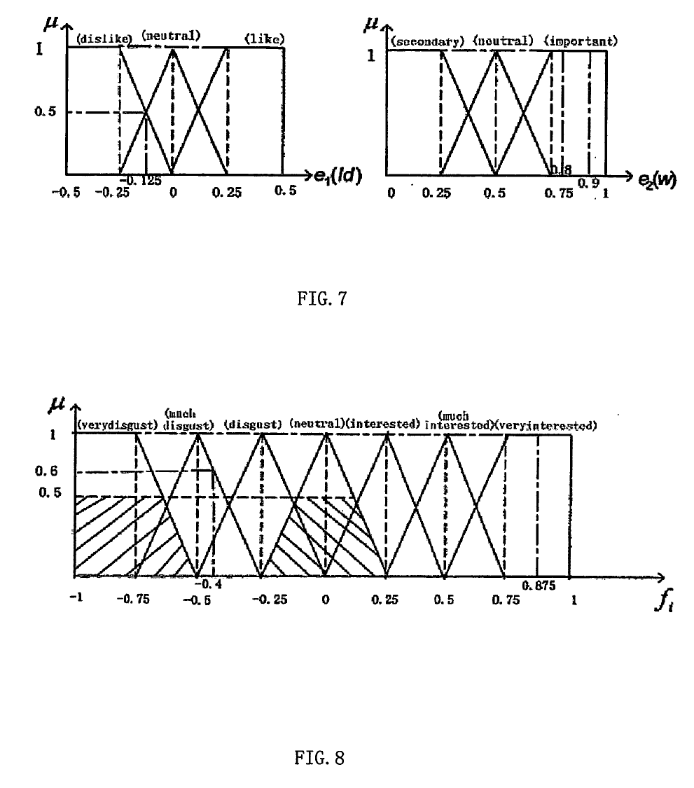

Secondly, the preference, weight and the interest-degree for the specific information characteristic may be fuzzed (step S420). Suppose e₁=preference, e₂=weight. Where e₁≧0, it means that the user likes it. The greater e₁ is, the more the user likes it. Where e₁≦0, it means that the user dislikes it. The less the e₁ is, the more the user dislikes it. e₂ is always greater than 0. The greater e₂ is, the more important the program is. The fuzzy set of the interest-degree fᵢ for the specific information characteristic is set as shown in FIG. 6. How to establish the fuzzy set is further described in detail in the following 5 and FIG. 6. The specific information characteristic of the program is mapped into the fuzzy set for the established user file in FIG. 5. How to map the characteristic may be described in detail together with FIG. 7.

The specific information characteristic, for example the actor “Ge You”, the preference e₁ for whom in the user file is 0.5, which when mapped to the fuzzy set in the user file, indicates that user A likes him and μ_{ld=like}=1; in addition, the weight for actor, the specific information characteristic, in the user file is 0.8, which when mapped to the fuzzy set in the user file, indicates that it is important, and μ_{w=important}=1.

Another specific information characteristic, for example the actress Li Qinqin, the preference for whom in the user file is −0.125, which when mapped to the fuzzy set in the user file, indicates that user A does not like her, and μ_{ld=dislike}=0.5; besides, the user thinks she is not so important, and μ_{ld=neutral}=0.5; in addition, the weight for actor, the specific information characteristic, is 0.8, which when mapped to the fuzzy set of the user file, indicates this specific information characteristic is important, and μ_{w=important}=1.

Another specific information characteristic, fox example “movie”, the preference for which in the user file is 0.5, which when mapped to the fuzzy set in the user file, indicates that the user likes program of this genre, and μ_{ld=like}=1. In addition, the weight for program genre in the user file is 0.9, which when mapped to the fuzzy set of the user file, indicates that it is important, and μᵢₘₚₒᵣₜₐₙₜ=1.

Thirdly, the fuzzed preference and weight may be further fuzzed so as to obtain the fuzzy value of the fuzzed interest-degree fᵢ for the specific information characteristic.

The rules of fuzzy inference are shown as follows:

I. If e₁ is dislike and e₂ is secondary, then fᵢ is disgust;

II. If e₁ is dislike and e₂ is neutral, then fᵢ is much disgust;

III. If e₁ is dislike and e₂ is important, then fᵢ is very disgust;

IV. If e₁ is neutral and e₂ is secondary, then fᵢ is neutral;

V. If e₁ is neutral and e₂ is also neutral, then fᵢ is neutral;

VI. If e₁ is neutral and e₂ is important, then fᵢ is neutral;

VII. If e₁ is like and e₂ is secondary, then fᵢ is interested;

VIII. If e₁ is like and e₂ is neutral, then fᵢ is much interested;

IX. If e₁ is like and e₂ is important, then fᵢ is very interested.

According to the said fuzzy rules, it is obvious to see that, the specific information characteristic “Ge You ” complies with IX only. Where μ_{fi}=min(μ_{weight}, μ_{id}), the user, therefore, is very interested in this characteristic and μ_{fi}=1.

It is easy to see that, the information characteristic “Li Qinqin”, complies with both rules III and VI. For rule III, where μ_{fi}=min(μ_{weight}, μ_{id}), the user therefore very disgust this characteristic, and μ_{fi}=0.5; for rule VI, where μ_{fi}=min(μ_{weight}, μ_{id}), therefore the user thinks the characteristic is neutral, and μ_{fi}=0.5.

For the information characteristic “movie”, it only complies with rule IX only, and μ_{fi}=min(μ_{weight}, μ_{id}), therefore, the user is very interested in this characteristic and μ_{fi}=1.

Fourthly, after de-fuzzing the result from the said inference procedure, the definite value of fₗ of the interest-degree for the program is obtained(step S540).

In order to make the final result easy to be understood, the result of the fuzzy inference must be transformed into a clear value. The most common methods of de-fuzzing are Area Barycenter Method and Maximum Mean Method. The former is to synthesize all rules of the inspire output as the result, which is suitable for smooth control and is a common method for procedure control.

In this embodiment, Area Barycenter De-fuzzy Arithmetic is used, as shown in formular (3), n=9 is the number of the rules in the embodiment, n can also be the number of rules with other values.

$${f}_{i} = {\sum }_{i = 1}^{9} μ [ i ] \cdot {y}_{i} / {\sum }_{i = 1}^{9} μ [ i ] \qquad ( 3 )$$

Here, μ[i]: indicates the height of the output area deduced from rule i.
yᵢ: is the abscissa of the output area's barycenter deduced from rule i.

According to the above formula, we can obtain:

Ge You: fᵢ=0.875, Li Qinqin: fᵢ≈−0.4, Movie: fᵢ=0.875.

Then, map the said definite values to the fuzzy set of interest-degree for the specific information characteristic, so as to obtain the actual interest-degree of the user for every specific information characteristic. More explanation will be made together with FIG. 8.

Fifthly, the comprehensive interest-degree of the information characteristic will be obtained according to the interest-degrees for the specific information characteristic(step S450).

In order to evaluate the comprehensive interest-degree for program j, the mean method of the following formula (4) is applied to calculate:.

$${P}_{j} = \frac{( {f}_{j 1} + {f}_{j 2} + … + {f}_{j m} )}{m} \qquad ( 4 )$$

Here, m indicates the number of characteristic the information comprises. Through calculation, the interest-degree for the said program is:

$${P}_{j} = \frac{( {f}_{j 1} + {f}_{j 2} + … + {f}_{j m} )}{m} = \frac{( 0.875 - 0.4 + 0.875 )}{3} = 0.45$$

0.45 then is mapped to the fuzzy set of the comprehensive interest-degree for the program Pⱼ. Detail description may be made in combination with FIG. 9. Finally, the user's comprehensive interest-degree for the program is somewhere between “much interested ” and “interested”, with μ_{interested}≈0.2, and μ_{much interested}≈0.8. Compared with the traditional recommendation system, which can only provide a simple value, the recommendation system of this invention reflects the user's feeling clearly.

Another way of matching the program is, instead of applying Mean Method to get the value of the interest-degree Pⱼ, fⱼₘ can be mapped to the fuzzy set directly. Then, a fuzzy control system with multi-input and single output may be established, while the output value is the comprehensive interest-degree Pⱼ.

FIG. 5 is a fuzzy set of the weight and preference in the user file according to an embodiment of the invention. In FIG. 5, p expresses the subjection degree of e₁=preference, e₂=weight, i.e. degree. Therefore, the fuzzy sets of the two variables e₁ and e₂ of the user file can be shown in FIG. 5, with the fuzzy sets for e₁ as (dislike, neutral, like), the fuzzy sets for e₂ as (secondary, neutral, important). When e₁≧0, it means the user “likes ” it, and the greater the e₁, the more the user likes it; when e₁≦0, it means the user “dislike ” it, and the less the e₁, the more the user dislikes it. e₂ is always greater than 0, while the greater e₂ is, the more important it is. It is to be noted that this fuzzy set and the below-mentioned shapes position can be varied to different situations. It is just an embodiment at here.

FIG. 6 is a fuzzy set of the interest-degree for the specific information characteristic according to an embodiment of the invention. Here, fᵢ is the interest-degree for information characteristic i of the program. According to the shape of the fuzzy set in FIG. 5, a fuzzy set of the interest-degree for the information characteristic may be established, as shown in the Figure (very disgust, much disgust, disgust, neutral, interest, much interest, very interest). The greater fᵢ is, the greater the user's interest-degree for the specific information characteristic is, which means the user is more interested in the specific information characteristic. The fuzzy set for the said comprehensive interest degree can adopt the same fuzzy set for the interest-degree of the information characteristic.

FIG. 7 is a sketch map showing the result of mapping the interest-degree for the information characteristic of a program to a fuzzy set of the user file according to an embodiment of the invention. The system maps the received specific information characteristic of the program to the established fuzzy sets of the preference and weight in the user file, as shown in the FIG. 5, so as to obtain the preference and weight of the user for the information characteristic. In this embodiment, the system maps the information characteristic of the program “Cala, My Dog ” to the established fuzzy set of the user file, as shown in FIG. 5. The result of the reflection is shown in FIG. 7 as:

The specific information characteristic, for instance “Ge You”, the preference e₁ for whom is 0.5, which when mapped in the fuzzy set of the user file, it shows that user A likes him, and μ_{ld=like}=1; in addition, the weight for the specific information characteristic “Actor ” is 0.8, which when mapped to the fuzzy set of the user file, it shows that it is important, and μ_{w=important} =1.

Another specific information characteristic, for example, the actress Li Qinqin, the interest degree for whom is −0.125, which when mapped to the fuzzy set of the user file, it shows user A dislikes her, and μ_{ld}=dislike=0.5; and at the same time, the user feels she's neutral, and μ_{ld=neutral}=0.5; in addition, the weight for the specific information characteristic “Actor ” is 0.8, which when mapped to the fuzzy set of the user file, it shows that it is important, and μ_{w=important}=1.

Another specific information characteristic, for example, “movie”, the interest degree for which is 0.5, which when mapped to the fuzzy set of the user file, it shows the user likes this genre, and μ_{ld=like}=1; in addition, the weight for the specific information characteristic “program genre ” is 0.9, which when mapped to the fuzzy set of the user file, it shows that it is important, and μ_{w=important}=1.

FIG. 8 is a sketch showing the result of the interest degree of certain information characteristic of an embodiment of this invention when reflected on its fuzzy set. The system maps the interest-degree fᵢ of the information characteristic after de-fuzzing to the established fuzzy set of interest-degree fi, as show in FIG. 6, so as to obtain the actual interest-degree of the user for the information characteristic. It then maps the definite value of the interest-degree for the information characteristics in the program “Cala, My Dog ” to the fuzzy set, we can see from FIG. 8 that:

Specific information characteristic, Ge You: fᵢ=0.875, which indicates that the audience are interested in the information characteristic “Ge You”;

Specific information characteristic, Li Qinqin: fᵢ≈−0.4, which indicates that the audience much disgusts the information characteristic “Li Qinqin”;

Specific information characteristic, Movie: fᵢ≈0.875, which indicates that the audiences are very interested in the information characteristic “Movie”.

FIG. 9 is a sketch map showing the result of mapping the comprehensive interest-degree for a program to its fussy set according to an embodiment of the invention. The fuzzy set of the comprehensive interest-degrees can be expressed as (very disgust, much disgust, disgust, neutral, interested, much interested, very interested). After obtaining the comprehensive interest-degree Pⱼ for the program through calculation, the system then maps the definite value to the fuzzy set in FIG. 9, so as to obtain the final comprehensive interest-degree of the user for the program. The degree might be somewhere between “interest” and “much interest ” etc. As shown in FIG. 9, mapping the calculated comprehensive interest-degree 0.45 to the fuzzy set of the comprehensive interest-degree Pⱼ of the program, it clearly indicates the user's feeling towards the program. The user's interest degree is between “much interested ” and “interested”, and μ_{interested}≈0.2, μ_{much-interested}≈0.8.

In addition, the threshold is also selected through the fuzzy set in FIG. 9. If the threshold is set as: interest-degree is “much interested”; and μ_{much-interested}=0.5, which corresponds to fuzzy set of comprehensive interest-degree in FIG. 9. When mapped in the abscissa, two values 0.375 and 0.625 are obtained. The minimum value is acquired as λ=0.375, thus the requirement for the information of the comprehensive interest-degree greater than λ is met.

This invention can be combined with EPG to provide user with information of TV program, telling them when and on which channel they can find interesting programs. The recommendation system can mark on the EPG which program complying with the user's interest and the like degree thereof.

The recommendation system of this invention can also be built in Set Top Box (STB) or Personal Digital Recorder (PDR), which then can help users record programs that they like, enabling them to watch their favorite programs at any convenient time. The user is encouraged to use the recommendation system of this invention to create a virtual personal channel and enjoy it. Of course, this invention is not only restricted to TV or Radio program, It applies to recommendations from any other source, including shopping and any information involving with audio, video, picture, advertisement, articles on Internet or intranet. The embodiments of the aforementioned items can be realized through the recommendation system and method described in this invention.

Although much has been said regarding the embodiment of this invention, it is obvious to the skills of the art that many alternation, modification or change can be made based on the description to the system. Therefore, the possible alternation, modification and change, which fall in the of the spirit or scope of the claims of this invention, should be included in this invention.

What is claimed is:

1. A method for recommending information, including the steps of:
a. receiving the information which includes the specific information characteristics;
b. matching said information with a user file which includes the user's selecting characteristic by inference of the fuzzy logic; and
c. recommending the information which conforms to the predetermined conditions to the user according to the matching result.

2. The method according to claim 1, further including the step of: updating said user file according to the user's feedback for the recommended information.

3. The method according to claim 2, wherein the method for said updating the user file includes: judging the actual user's interest-degree according to the relative ratio of the time in which the user watches the recommended information to the time in which said information is predetermined to broadcast actually, thereby to update the user's parameters.

4. The method according to claim 1, wherein said selecting characteristic includes a ternary array which includes the content characteristic, the preference and the weight.

5. The method according to claim 4, wherein said preference represents the degrees of the user's like and dislike.

6. The method according to claim 4, wherein the preference and the weight of said selecting characteristic is expressed with the fuzzy set.

7. The method according to claim 4, wherein said user file can be expressed with the following vector formula of the ternary array:
UP=((t₁, ld₁, w₁), (t₂, ld₂, w₂), . . . (tᵢ, ldᵢ, wᵢ) . . . (tₘ, ldₘ, wₘ))
wherein (ti, ldi, wi) is a said selecting characteristic, tᵢ is a content characteristic, i is the serial number of the content characteristic tᵢ, ldᵢ is the preference for the selecting characteristic, wᵢ is the weight of the selecting characteristic.

8. The method according to claim 1, wherein said user file is established in a fuzzy manner.

9. The method according to claim 1, wherein said step b includes the steps of:
i. matching the specific information characteristic of said information with the relative selecting characteristic in said user file to obtain the user's interest-degree for said specific information characteristic by inference of the fuzzy logic; and
ii. obtaining the user's comprehensive interest-degree for said information according to the obtained interest-degree for said specific information characteristic.

10. The method according to claim 9, wherein said step i includes the steps of:
A. establishing a transforming mode for the variable with multi-input and single-output, said input variable being the user's selecting characteristic, said output variable being the interest-degree for the specific information characteristic;
B. fuzzing said selecting characteristic and said interest-degree for the specific information characteristic;
C. making a fuzzy process for the fuzzed selecting characteristic to obtain the fuzzed interest-degree for the specific information characteristic;
D. de-fuzzing the processing result to obtain the definite value of the interest-degree for the specific information characteristic.

11. The method according to claim 10, wherein said step ii including the steps of:
A. establishing a transforming mode for the variable with multi-input and single-output, said input variable being the interest-degree for the specific information characteristic, said output variable being the comprehensive interest-degree for the information;
B. mapping said interest-degree for the specific information characteristic to the comprehensive interest-degree for the information obtained with the fuzzy set.

12. An system for information recommending, including: information receiving means for receiving the information which includes the specific information characteristic;
fuzzy matching means for matching the received information with a user file which includes the user's selecting characteristic by inference of the fuzzy logic;
sieving means for recommending the information which conforms to the predetermined conditions to the user according to the matching result.

13. The system according to claim 12, further including: user communicating means for user's communicating the information with said system.

14. The system according to claim 12, further including: user file revising means for updating the user's file according to the user's feedback for the recommended information.

15. The system according to claim 12, further including: fuzzy user file managing means for storing the fuzzed user files.
